(19) United States
(12) Patent Application Publication
(10) Pub. No.: US 2026/0341898 A1
(43) Pub. Date: Oct. 29, 2026

(54) BUSBAR MODULE CASE

(71) Applicant: Yazaki Corporation, Tokyo (JP)

(72) Inventors: Yasuhiro KOMINATO, Shizuoka (JP); Katsunori SATO, Shizuoka (JP); Mariko NAKAGAWA, Shizuoka (JP); Kota MORISHIGE, Shizuoka (JP); Mikiko SATO, Shizuoka (JP)

(73) Assignee: Yazaki Corporation, Tokyo (JP)

(21) Appl. No.: 19/632,717

(22) Filed: Mar. 30, 2026

(30) Foreign Application Priority Data
Apr. 25, 2025 (JP) 2025-073112

(51) Int. Cl. H01M 50/367; H01M 50/507

(52) U.S. Cl. CPC H01M 50/367; H01M 50/507

(57) ABSTRACT

A busbar module case includes: a case body that is formed of resin and holds a plurality of busbars connected to a battery cell. The case body includes: a holding portion that holds the busbars; a wiring path in which a wiring member connected to the busbars is disposed; and a duct portion capable of guiding gas discharged from the battery cell. The case body is configured by coupling a plurality of case components aligned in an extending direction of the wiring path with each other. The plurality of case components include at least two first case components. The first case components are identically shaped and can be coupled with each other. The duct portion is formed by connecting arch portions of the plurality of case components with each other.

### CROSS-REFERENCE TO RELATED APPLICATIONS

The present application claims priority to and incorporates by reference the entire contents of Japanese Patent Application No. 2025-073112 filed in Japan on Apr. 25, 2025.

### BACKGROUND OF THE INVENTION

### 1. Field of the Invention

The present invention relates to a busbar module case.

### 2. Description of the Related Art

There is known an exhaust gas duct that discharges gas discharged from a battery to the outside of a vehicle. Japanese Patent Application Laid-open No. JP 2018 - 055 843 A discloses a power storage device in which an exhaust gas duct extending in a front-rear direction of a battery assembly is disposed.

It is desirable to achieve cost reduction in the busbar module. For example, when the exhaust gas duct is a component separate from the case for holding the busbar, it is likely to lead to an increase in cost. For example, when dedicated ducts or cases are prepared for battery modules having different numbers of cells, it is likely to lead to an increase in cost.

### SUMMARY OF THE INVENTION

An object of the present invention is to provide a busbar module case capable of reducing cost.

In order to achieve the above mentioned object, a busbar module case according to one aspect of the present invention includes a case body that is formed of resin and holds a plurality of busbars connected to a battery cell, wherein the case body includes: a holding portion that holds the busbar; a wiring path in which a wiring member connected to the busbar is disposed; and a duct portion capable of guiding gas discharged from the battery cell, the case body is configured by coupling a plurality of case components aligned in an extending direction of the wiring path with each other, the plurality of case components include at least two first case components, the first case components are identically shaped and can be coupled with each other, and the duct portion is formed by connecting arch portions of the plurality of case components with each other.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a busbar module case according to an embodiment;

FIG. 2 is a plan view of the busbar module case according to the embodiment;

FIG. 3 is an exploded perspective view of the busbar module case according to the embodiment;

FIG. 4 is a cross-sectional view of the busbar module case according to the embodiment;

FIG. 5 is a plan view of the busbar module according to the embodiment;

FIG. 6 is a cross-sectional view of the busbar module according to the embodiment; and

FIG. 7 is a cross-sectional view of the busbar module according to the embodiment.

### DETAILED DESCRIPTION OF THE PREFERRED EMBODIMENTS

Hereinafter, a busbar module case according to an embodiment of the present invention will be described in detail with reference to the drawings. The present invention is not limited by the embodiment. Moreover, components in the following embodiment include those that are easily conceivable for those skilled in the art or substantially identical.

### Embodiment

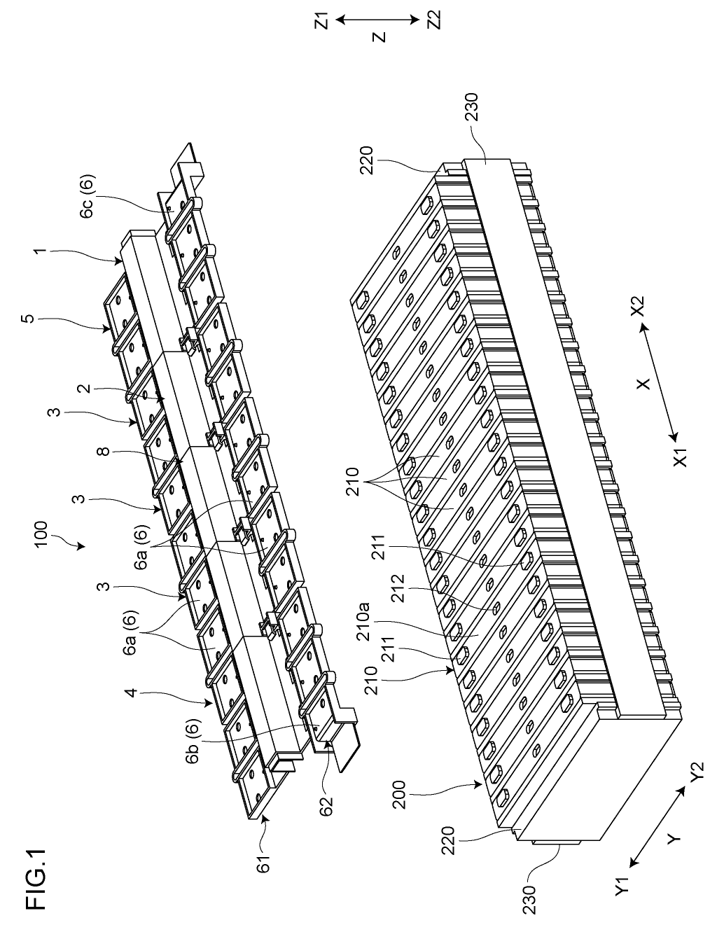

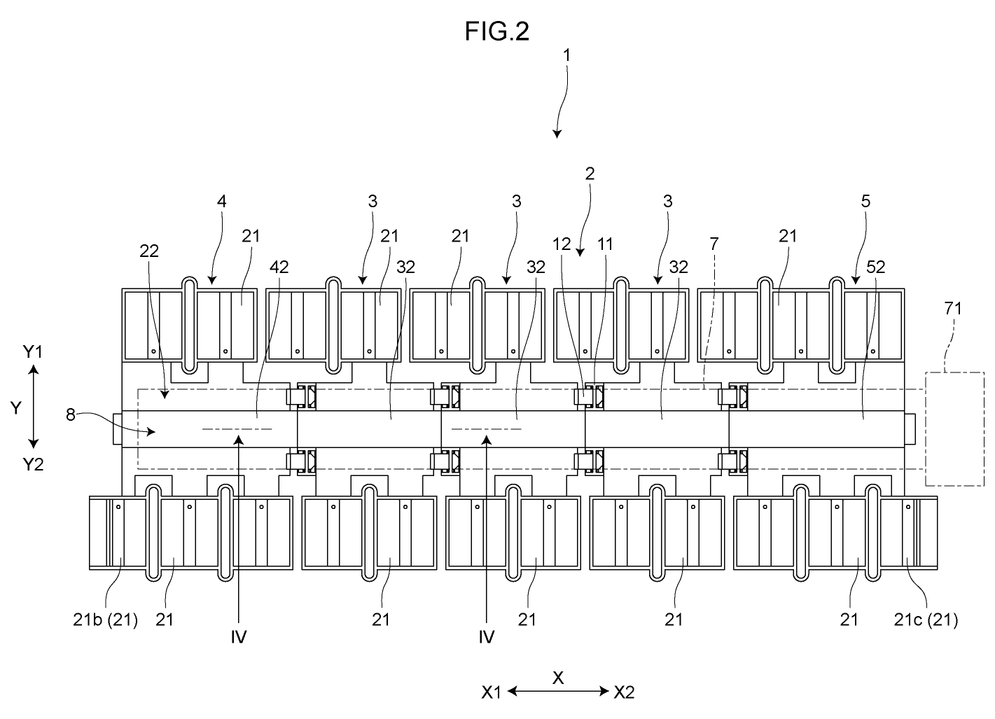

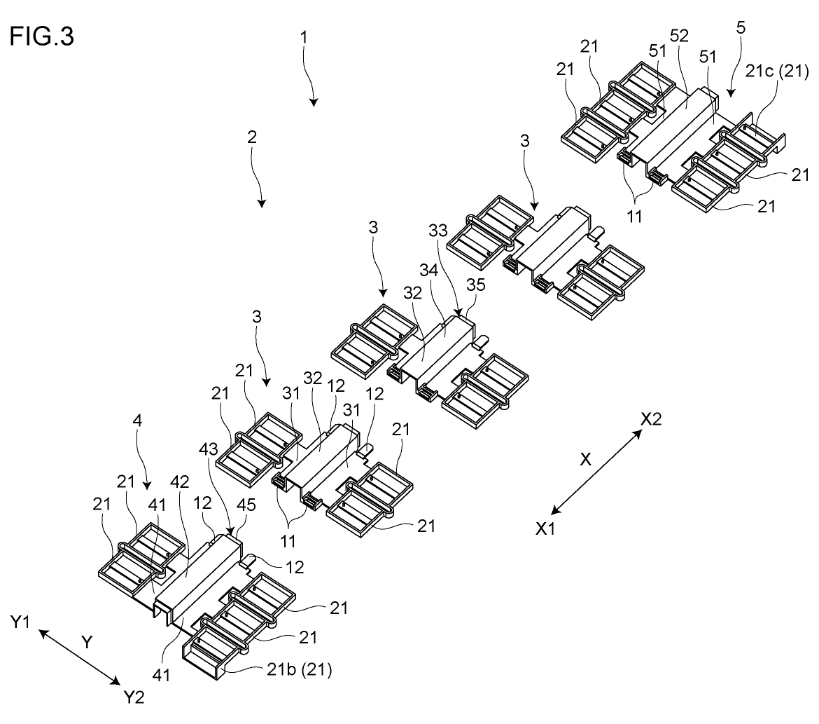

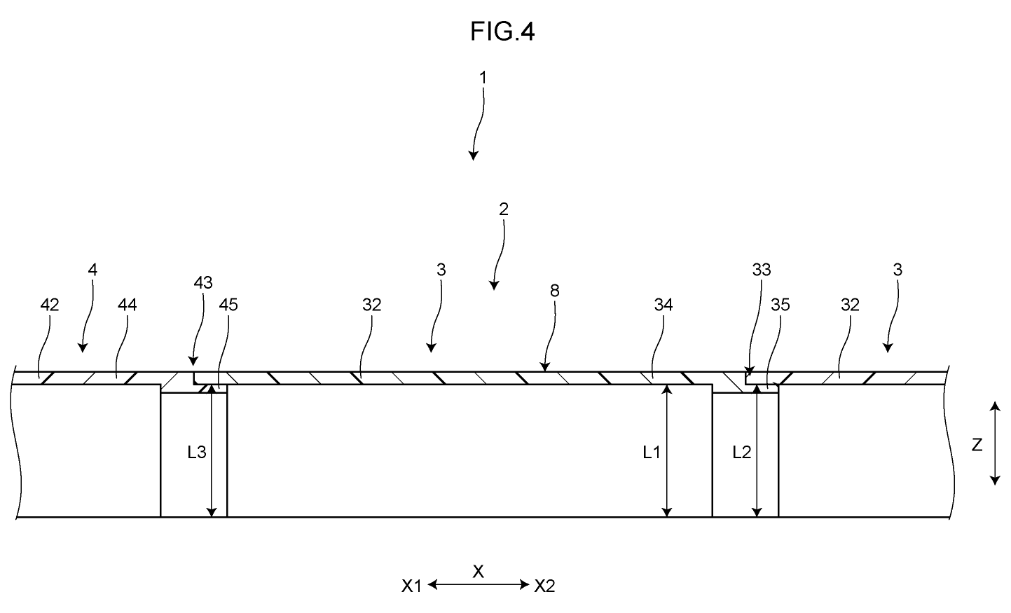

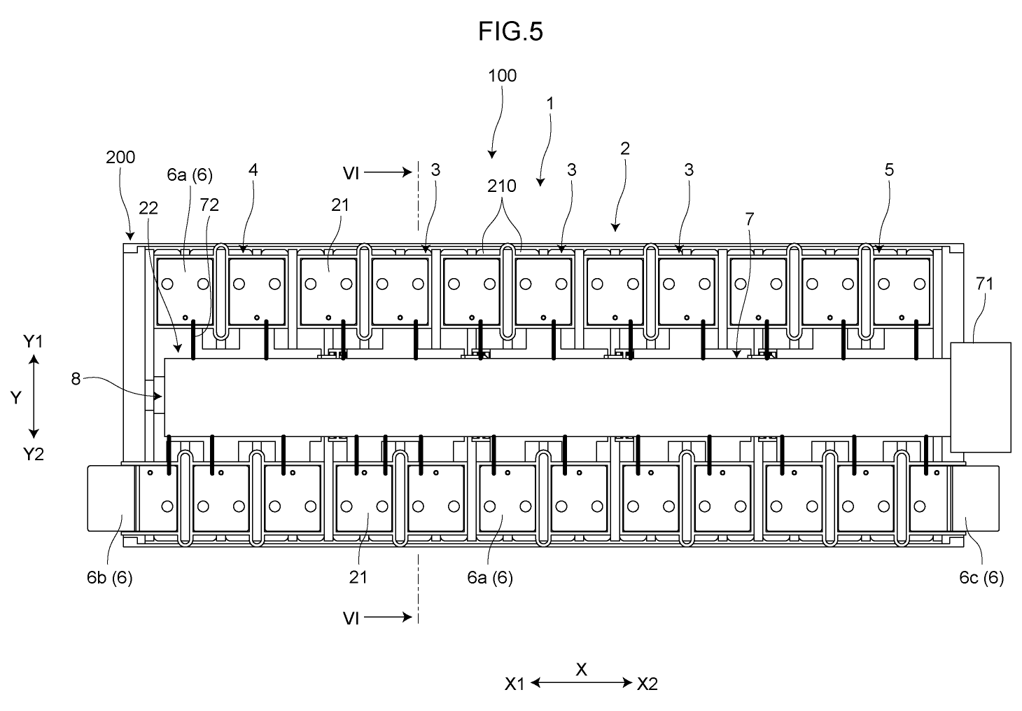

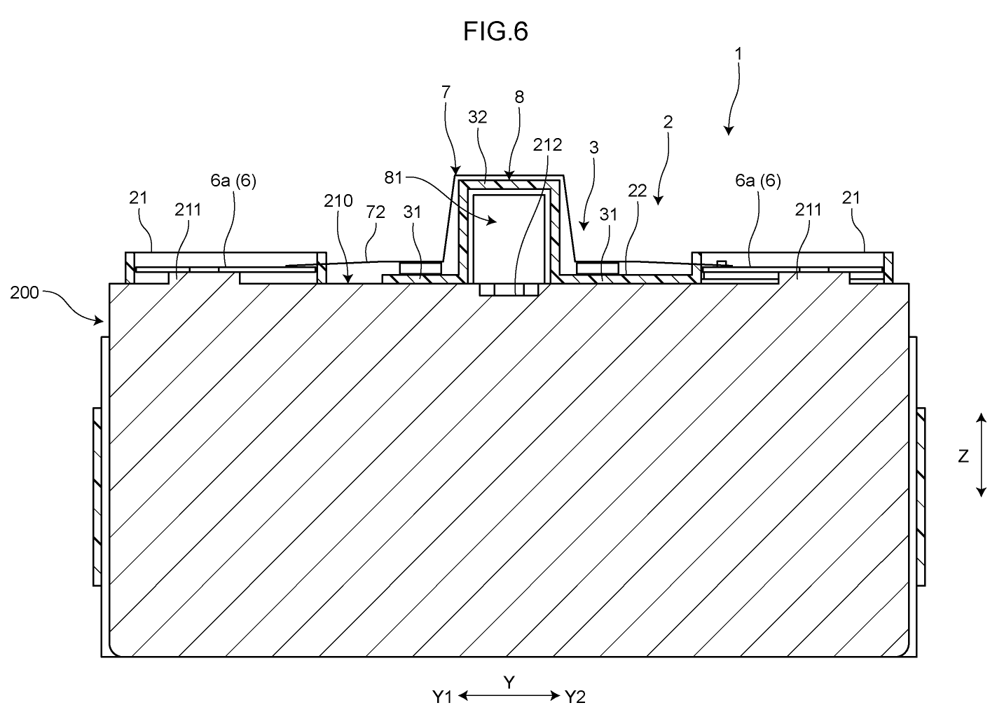

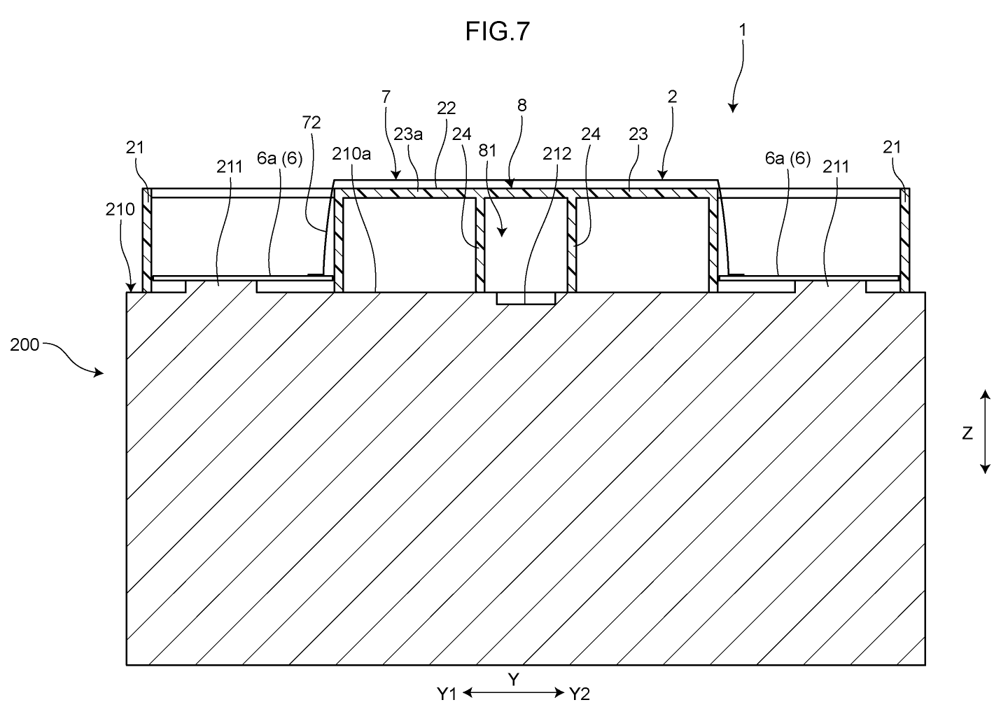

An embodiment will be described with reference to FIGS. 1 to 7. The present embodiment relates to a busbar module case. FIG. 1 is a perspective view of a busbar module case according to the embodiment, FIG. 2 is a plan view of the busbar module case according to the embodiment, FIG. 3 is an exploded perspective view of the busbar module case according to the embodiment, FIG. 4 is a cross-sectional view of the busbar module case according to the embodiment, FIG. 5 is a plan view of the busbar module according to the embodiment, and FIGS. 6 and 7 are cross-sectional views of the busbar module according to the embodiment. FIG. 4 illustrates a cross section taken along line IV-IV of FIG. 2. FIG. 6 illustrates a cross section taken along line VI-VI of FIG. 5.

As illustrated in FIG. 1, a busbar module 100 of the present embodiment includes a busbar module case 1 and a plurality of busbars 6. As illustrated in FIG. 5, the busbar module 100 further includes a wiring member 7 wired to the busbar module case 1.

The busbar module 100 is assembled to a battery module 200. As illustrated in FIG. 1, the battery module 200 includes a plurality of battery cells 210 aligned in a first direction X. The battery cell 210 of the present embodiment has a substantially rectangular parallelepiped shape. The battery cell 210 includes a top surface 210a having a substantially rectangular shape. The plurality of battery cells 210 are arranged such that the longitudinal direction of the top surface 210a is orthogonal to the first direction X. In the following description, the longitudinal direction of the top surface 210a is denoted as a second direction Y. A direction orthogonal to both the first direction X and the second direction Y is denoted as a third direction Z. The third direction Z is a height direction of the battery cell 210. The top surface 210a is an end surface of the battery cell 210 on a first side Z1 in the third direction Z.

The battery module 200 is mounted, with the top surface 210a facing the upper side in the vehicle up-down direction, as a power source, on a vehicle such as an automobile. That is, in a state where the battery module 200 is mounted on the vehicle, the first side Z1 in the third direction Z is the vehicle upper side, and the second side Z2 is the vehicle lower side. The plurality of battery cells 210 are held by a pair of end plates 220 and a pair of side plates 230.

One battery cell 210 has two electrodes 211 and one discharge port 212. The electrode 211 and the discharge port 212 are disposed on the top surface 210a. The electrodes 211 are distributed one by one at both ends of the top surface 210a in the second direction Y. The discharge port 212 is an exhaust valve capable of discharging a gas from the inside of the battery cell 210, and opens in accordance with the internal pressure of the battery cell 210, for example. The position of the discharge port 212 is a position between the two electrodes 211, and is an intermediate position between the two electrodes 211, for example.

The busbar module case 1 is assembled to the battery module 200 so as to cover the battery module 200 from the upper side in the vehicle up-down direction. The busbar 6 held by the busbar module case 1 is connected to the electrode 211 of the battery cell 210. The busbar 6 is joined to the electrode 211 by welding, for example.

The busbar module 100 includes a first busbar group 61 and a second busbar group 62. The first busbar group 61 and the second busbar group 62 each include a plurality of busbars 6 aligned in the first direction X. The busbar 6 of the first busbar group 61 is connected to the electrode 211 located on a first side Y1 in the second direction Y. The busbar 6 of the second busbar group 62 is connected to the electrode 211 located on a second side Y2 in the second direction Y.

The plurality of busbars 6 include a connection busbar 6a and two end portion busbars 6b and 6c. The connection busbar 6a electrically connects the electrodes 211 of two adjacent battery cells 210 with each other. The connection busbar 6a connects two battery cells 210 in series, for example. The end portion busbars 6b and 6c are busbars 6 that connect the battery module 200 to the outside. The end portion busbars 6b and 6c are disposed at ends of the plurality of busbars 6 in the first direction X. One of the end portion busbars 6b and 6c is connected to the total positive electrode of the battery module 200, and the other is connected to the total negative electrode of the battery module 200.

In the busbar module 100 of the present embodiment, the two end portion busbars 6b and 6c are disposed in the second busbar group 62. In this case, the two end portion busbars 6b and 6c are disposed at both ends of the second busbar group 62.

The busbar module case 1 includes a case body 2 formed of resin. As illustrated in FIGS. 2 and 3, the case body 2 includes a plurality of first case components 3, a second case component 4, and a third case component 5. The first case components 3 can be coupled with each other. The second case component 4 and the third case component 5 can be coupled with the first case component 3. By changing the number of the first case components 3, the busbar module case 1 of the present embodiment can easily handle the battery modules 200 of various cell numbers.

The busbar module case 1 of the present embodiment includes a duct portion 8. The duct portion 8 is a flow path capable of guiding gas discharged from the battery cells 210. The duct portion 8 is configured by connecting arch portions of the plurality of case components 3, 4, and 5 with each other. By changing the number of the first case components 3, the busbar module case 1 of the present embodiment can set the length of the duct portion 8 to a length corresponding to the number of cells of the battery module 200.

As illustrated in FIG. 2, the shape of the case body 2 in plan view is substantially a rectangular shape. The case body 2 includes: a plurality of holding portions 21 that hold the busbars 6; and a wiring path 22. The holding portions 21 are disposed at both ends of the case body 2 in the second direction Y. The holding portions 21 on the first side Y1 hold the busbars 6 of the first busbar group 61, while the holding portions 21 on the second side Y2 hold the busbars 6 of the second busbar group 62.

The wiring path 22 supports the wiring member 7 connected to the busbar 6. The wiring member 7 is, for example, a flat wiring member such as a flexible printed circuit board, or an electric wire bundle. The wiring member 7 extends along the wiring path 22 in the first direction X. In other words, the plurality of case components 3, 4, and 5 are aligned in the extending direction of the wiring member 7. The wiring member 7 includes: a plurality of detection lines connected to the busbars 6; and a connector 71 connected to the detection lines. The connector 71 is connected to a monitoring device that monitors the battery module 200, for example.

As illustrated in FIG. 3, the first case components 3 are identically shaped. The first case component 3 includes a plurality of holding portions 21, a pair of bottom walls 31, and an arch portion 32. The holding portion 21, the bottom wall 31, and the arch portion 32 are integrally molded with insulating synthetic resin, for example. The bottom wall 31 is placed on the top surface 210a of the battery cell 210 and faces the top surface 210a. The bottom wall 31 has a substantially flat plate shape and extends in the first direction X. The bottom walls 31, provided in pair, are disposed at intervals in the second direction Y. The arch portion 32 is disposed between the pair of bottom walls 31 and extends in the first direction X. The arch portion 32 has an arch shape and protrudes from the bottom wall 31 toward a direction orthogonal to the bottom wall 31. The arch portion 32 protrudes toward the side opposite to the side of the battery cell 210. The cross-sectional shape of the arch portion 32 is rectangular, for example.

The holding portions 21 are disposed at both ends of the first case component 3 in the second direction Y. The holding portion 21 is connected to the bottom wall 31 and extends from the bottom wall 31 toward the second direction Y. The first case component 3 has the same number of holding portions 21 on the first side Y1 and the second side Y2. Each of the holding portions 21 of the first case component 3 is configured to hold the connection busbar 6a. That is, the first case component 3 holds the same number of connection busbars 6a on both sides in the second direction Y. The exemplified first case component 3 has two holding portions 21 on both sides in the second direction Y.

The first case component 3 includes two first engagement portions 11 and two second engagement portions 12. The first engagement portion 11 is disposed at one end portion of the bottom wall 31, and the second engagement portion 12 is disposed at the other end portion of the bottom wall 31. In the exemplified first case component 3, the first engagement portion 11 is disposed at the end portion on the first side X1 of the bottom wall 31, and the second engagement portion 12 is disposed at the end portion on the second side X2 of the bottom wall 31.

The second engagement portion 12 is a protruding piece protruding from the bottom wall 31 in the first direction X. The second engagement portion 12 has a claw locked by the first engagement portion 11. The first engagement portion 11 has a tubular shape or a frame shape into which the second engagement portion 12 can be inserted. The first engagement portion 11 has a locking portion that locks the claw of the second engagement portion 12. By engaging the first engagement portion 11 of one first case component 3 and the second engagement portion 12 of the other first case component 3 with each other, the two first case components 3 are coupled with each other.

The second case component 4 includes a plurality of holding portions 21, a pair of bottom walls 41, and an arch portion 42. The holding portion 21, the bottom wall 41, and the arch portion 42 are integrally molded with insulating synthetic resin, for example. The configurations of the bottom wall 41 and the arch portion 42 are similar to the configurations of the bottom wall 31 and the arch portion 32 of the first case component 3. For example, the cross-sectional shape of the arch portion 42 is similar to the cross-sectional shape of the arch portion 32 of the first case component 3.

The holding portions 21 are disposed at both ends of the second case component 4 in the second direction Y. The holding portion 21 is connected to the bottom wall 41 and extends from the bottom wall 41 toward the second direction Y. The plurality of holding portions 21 of the second case component 4 include: holding portions 21 configured to hold the connection busbars 6a; and holding portions 21b configured to hold the end portion busbars 6b. The second case component 4 holds the same number of connection busbars 6a on both sides in the second direction Y, and further holds the end portion busbars 6b.

The second case component 4 includes two second engagement portions 12. The second engagement portion 12 is disposed at an end portion of the bottom wall 41 on the first case component 3 side. By engaging the second engagement portion 12 of the second case component 4 and the first engagement portion 11 of the first case component 3 with each other, the two case components 3 and 4 are coupled with each other.

The third case component 5 includes a plurality of holding portions 21, a pair of bottom walls 51, and an arch portion 52. The holding portion 21, the bottom wall 51, and the arch portion 52 are integrally molded with insulating synthetic resin, for example. The configurations of the bottom wall 51 and the arch portion 52 are similar to the configurations of the bottom wall 31 and the arch portion 32 of the first case component 3. For example, the cross-sectional shape of the arch portion 52 is similar to the cross-sectional shape of the arch portion 32 of the first case component 3.

The holding portions 21 are disposed at both ends of the third case component 5 in the second direction Y. The holding portion 21 is connected to the bottom wall 51 and extends from the bottom wall 51 in the second direction Y. The plurality of holding portions 21 of the third case component 5 include: a holding portion 21 configured to hold the connection busbar 6a; and a holding portion 21c configured to hold the end portion busbar 6c. The third case component 5 holds the plurality of connection busbars 6a on both sides in the second direction Y, and further holds the end portion busbar 6c.

The third case component 5 includes two first engagement portions 11. The first engagement portions 11 are disposed at end portions of the bottom wall 51 on the first case component 3 side. By engaging the first engagement portion 11 of the third case component 5 and the second engagement portion 12 of the first case component 3 with each other, the two case components 3 and 5 are coupled with each other.

As illustrated in FIG. 2, the duct portion 8 is configured by fitting arch portions 32, 42, and 52 of the plurality of case components 3, 4, and 5 with each other. More specifically, as illustrated in FIGS. 3 and 4, the arch portions 32 and 42 have stepped shapes 33 and 43, respectively. The stepped shapes 33 and 43 are provided at end portions of the arch portions 32 and 42 in the first direction X. The stepped shapes 33 and 43 are formed so as to be fittable with other arch portions 32 and 52 adjacent to the arch portions 32 and 52.

For example, the stepped shape 33 of the first case component 3 is formed so as to be fittable with the arch portion 32 of another first case component 3 or with the arch portion 52 of the third case component 5. The stepped shape 33 is formed at a boundary between a main body portion 34 and an insertion portion 35 of the arch portion 32. The main body portion 34 is a main portion of the arch portion 32, and extends from the end portion on the first side X1 to the vicinity of the end portion on the second side X2 in the arch portion 32. The insertion portion 35 is an end portion of the arch portion 32 on the second side X2.

The insertion portion 35 can be inserted into the main body portion 34 to be fitted with the main body portion 34. As illustrated in FIG. 4, an outer dimension L2 of the insertion portion 35 in the third direction Z is equal to or slightly smaller than an inner dimension L1 of the main body portion 34. Similarly, the outer dimension of the insertion portion 35 in the second direction Y is equal to or slightly smaller than the inner dimension of the main body portion 34. By inserting the insertion portion 35 into the main body portion 34, the two arch portions 32 are coupled with each other to form a continuous exhaust passage.

The insertion portion 35 can also be fitted with the arch portion 52 of the third case component 5. In this case, by inserting the insertion portion 35 into the arch portion 52, the two arch portions 32 and 52 are coupled with each other to form a continuous exhaust passage.

The stepped shape 43 of the second case component 4 is formed so as to be fittable with the arch portion 32 of the first case component 3. The stepped shape 43 is formed at a boundary between a main body portion 44 and an insertion portion 45 of the arch portion 42. The main body portion 44 is a main portion of the arch portion 42, and extends from the end portion on the first side X1 to the vicinity of the end portion on the second side X2 in the arch portion 42. The insertion portion 45 is an end portion of the arch portion 42 on the second side X2.

The insertion portion 45 can be inserted into the main body portion 34 of the first case component 3 to be fitted with the main body portion 34. An outer dimension L3 of the insertion portion 45 in the third direction Z is equal to or slightly smaller than the inner dimension L1 of the main body portion 34. Similarly, the outer dimension of the insertion portion 45 in the second direction Y is equal to or slightly smaller than the inner dimension of the main body portion 34. By inserting the insertion portion 45 into the main body portion 34, the two arch portions 42 and 32 are coupled with each other to form a continuous exhaust passage.

FIG. 5 illustrates the busbar module 100 assembled to the battery module 200. FIG. 6 illustrates a cross section taken along line VI-VI of FIG. 5. The wiring member 7 is disposed in the wiring path 22 of the busbar module case 1. The wiring member 7 is disposed so as to cover the duct portion 8, for example. Each detection line 72 of the wiring member 7 is connected to the corresponding busbar 6.

The busbar module case 1 is placed on the battery module 200 and assembled to the battery module 200. Each busbar 6 is connected to the electrode 211 of the corresponding battery cell 210. As illustrated in FIG. 6, the duct portion 8 faces the discharge port 212. The duct portion 8 protrudes toward the first side Z1 in the third direction Z with respect to the bottom wall 31, and forms a passage 81 capable of guiding gas. The gas discharged from the inside of the battery cell 210 via the discharge port 212 is guided by the duct portion 8 and discharged. The duct portion 8 is connected to a discharge path of a housing that accommodates the battery module 200, for example. The discharge path of the housing communicates between the duct portion 8 and the external space of the housing, and guides the gas to the external space.

The shape of the case body 2 is not limited to the shape in which the duct portion 8 protrudes upward. FIG. 7 illustrates another example of the case body 2. The case body 2 of FIG. 7 includes a holding portion 21, a top wall 23, and a pair of partition walls 24. The top wall 23 is a wall portion facing the top surface 210a of the battery cell 210 and has a substantially flat plate shape. The case body 2 is formed such that the top wall 23 faces the discharge port 212 of the battery cell 210.

The partition wall 24 is erected from the top wall 23 and extends in the first direction X. The case body 2 is assembled to the battery module 200 such that the partition wall 24 protrudes from the top wall 23 toward the battery cell 210. The partition walls 24, provided in pair, face each other in the second direction Y across the discharge port 212. The arch portion constituting the duct portion 8 is formed by the top wall 23 and the pair of partition walls 24. That is, the passage 81 of the duct portion 8 protrudes downward from the top wall 23 toward the battery cell 210 side.

The top wall 23 extends from the duct portion 8 toward both sides in the second direction Y. The top wall 23 of FIG. 7 extends to the holding portion 21 in the second direction Y. The holding portions 21 are disposed on both sides in the second direction Y with respect to the duct portion 8. The wiring path 22 includes an upper surface 23a of the top wall 23. That is, the wiring member 7 is disposed in a region including the upper surface 23a of the top wall 23.

Each of the case components 3, 4, and 5 has a wall portion constituting the top wall 23, a wall portion constituting the partition wall 24, and the holding portion 21. The arch portion of each of the case components 3, 4, and 5 is formed of a wall portion constituting the top wall 23 and a wall portion constituting the partition wall 24. Accordingly, the duct portion 8 is formed by connecting arch portions of the plurality of case components 3, 4, and 5 with each other. At an end portion of the arch portion in the first direction X, there may be provided a stepped shape that can be fitted with another arch portion adjacent to the arch portion.

As described above, the busbar module case 1 of the present embodiment has the case body 2 formed of resin. The case body 2 is configured to hold the plurality of busbars 6 connected to the battery cells 210. The case body 2 includes the holding portion 21 that holds the busbar 6, the wiring path 22, and the duct portion 8. The wiring member 7 connected to the busbar 6 is disposed in the wiring path 22. The duct portion 8 is formed so as to be capable of guiding the gas discharged from the battery cells 210.

The case body 2 is configured by coupling a plurality of case components 3, 4, and 5 aligned in the extending direction of the wiring path 22 with each other. The plurality of case components 3, 4, and 5 include at least two first case components 3. The first case components 3 are identically shaped and can be coupled with each other. The duct portion 8 is formed by connecting arch portions 32, 42, and 52 of the plurality of case components 3, 4, and 5 with each other. With the busbar module case 1 of the present embodiment, cost can be reduced. For example, since the duct portion 8 is a part of the case body 2, the cost is reduced as compared with a case where the duct portion is a separate component. For example, when the case body 2 is configured by coupling the plurality of case components 3, 4, and 5 with each other, the case components can be shared by the battery modules 200 having different numbers of cells.

In at least one busbar module case 1 of the embodiment, the duct portion 8 protrudes upward in a state where the case body 2 is assembled to the battery cell 210. With such a configuration, for example, the flow path area of the passage 81 can be set to an appropriate size.

The stepped shapes 33 and 43 that can be fitted with other adjacent arch portions 32 and 52 may be provided at end portions of the arch portions 32 and 42 in the first direction X. Fitting the arch portions 32, 42, and 52 with each other enables forming the duct portion 8 in which gas hardly leaks.

In the busbar module case 1 exemplified in the embodiment, all the case components 3, 4, and 5 include the arch portions 32, 42, and 52, but the present invention is not limited thereto. Among the plurality of case components 3, 4, and 5, some case components need not include the arch portions. For example, the second case component 4 or the third case component 5 disposed at the end portion in the first direction X need not include the arch portions 42 and 52. In this case, a duct of a housing that houses battery module 200 may be disposed at positions of arch portions 42 and 52.

In the busbar module case 1 of the present embodiment, the arch portions 32, 42, and 52 have an arch shape opened toward the discharge port 212 side. Therefore, the busbar module case 1 can absorb the tolerance when the battery cell 210 is thermally expanded. For example, when the battery cell 210 thermally expands in the second direction Y, the protruding arch portions 32, 42, and 52 can be deformed so as to increase or decrease the opening width. Accordingly, the duct portion 8 of the present embodiment can absorb the tolerance due to thermal expansion.

The busbar module case 1 may include a cover that covers the case body 2 in addition to the case body 2. The cover is engaged with the case body 2 and covers the busbar 6 and the wiring member 7. The cover may be connected to the case body 2 via a hinge portion.

A sheet having heat resistance may be attached to the duct portion 8. The heat-resistant sheet is a mica sheet, for example. The heat-resistant sheet is attached to a surface surrounding the passage 81 in the duct portion 8, for example. With such a configuration, even when the resin which is a material of case body 2 does not have high heat resistance, heat resistance of duct portion 8 can be enhanced.

The contents disclosed in the above embodiment can be executed in appropriate combination with each other.

In the busbar module case according to the present embodiment, the plurality of case components include at least two first case components. The first case components are identically shaped and can be coupled with each other. The duct portion is formed by connecting arch portions of the plurality of case components with each other. The busbar module case according to the present embodiment has an effect of achieving cost reduction.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A busbar module case comprising:
a case body that is formed of resin and holds a plurality of busbars connected to a battery cell, wherein
the case body includes: a holding portion that holds the busbar; a wiring path in which a wiring member connected to the busbar is disposed; and a duct portion capable of guiding gas discharged from the battery cell,
the case body is configured by coupling a plurality of case components aligned in an extending direction of the wiring path with each other,
the plurality of case components include at least two first case components,
the first case components are identically shaped and can be coupled with each other, and
the duct portion is formed by connecting arch portions of the plurality of case components with each other.

2. The busbar module case according to claim 1, wherein
the duct portion protrudes upward in a state where the case body is assembled to the battery cell.

3. The busbar module case according to claim 1, wherein
at an end portion of the arch portion in the extending direction, there is provided a stepped shape fittable with
another arch portion adjacent to the arch portion.
